(19) United States
(12) Patent Application Publication
(10) Pub. No.: US 2026/0371288 A1
(43) Pub. Date: Nov. 19, 2026

(54) POSITIONING METHOD AND APPARATUS, AND COMMUNICATION DEVICE AND STORAGE MEDIUM

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 19/144,156

(22) PCT Filed: Dec. 28, 2022
(86) PCT No.: PCT/CN2022/142746

§ 371 Date: Jun. 27, 2025

(51) Int. Cl. H04W 64/00

(52) U.S. Cl. CPC H04W 64/00

(57) ABSTRACT

A method and apparatus are provided for managing global navigation satellite system (GNSS) measurements in a wireless communication system. In one aspect, a user equipment (UE) determines time information for a GNSS measurement based on measurement configuration information, and evaluates, according to a predefined execution rule, whether to perform the measurement within a specified time range. The execution rule may consider the availability duration of existing GNSS position information to optimize measurement timing and reduce redundant processing. Depending on the decision, the UE may send different response information or withhold GNSS assistance information within a feedback period. In another aspect, an access network device transmits configuration and trigger information to guide UE behavior, and interprets the UE's response to determine whether a GNSS measurement was performed.

### CROSS REFERENCE TO RELATED APPLICATIONS

The present application is a U.S. National Stage of International Application No. PCT/CN2022/142746, filed on Dec. 28, 2022, all contents of which are incorporated herein by reference in their entirety for all purposes.

### TECHNICAL FIELD

The present application relates to the field of wireless communication technologies, but is not limited to the field of wireless communication technologies, and in particular, to a positioning method and apparatus, a communication device, and a storage medium.

### BACKGROUND

A global navigation satellite system (GNSS) generally refers to all satellite navigation systems, including global satellite navigation systems, regional satellite navigation systems and enhanced satellite navigation systems, such as the global positioning system (GPS) of the United States, the GLONASS of Russia, the Galileo of Europe, the Beidou satellite navigation system of China, and related enhancement systems, such as the wide area augmentation system (WAAS) of the United States, the European geostationary navigation overlay service (EGNOS) of Europe and the multi-functional satellite augmentation system (MSAS) of Japan, etc. The global navigation satellite system also covers other satellite navigation systems being built and to be built later.

### SUMMARY

According to a first aspect of the embodiments of the present disclosure, there is provided a positioning method, applied to user equipment (UE), and including:
determining time information of a global navigation satellite system (GNSS) measurement according to measurement configuration information; and
determining, according to an execution rule, whether to perform the GNSS measurement within a time range indicated by the time information.

According to a second aspect of the embodiments of the present disclosure, there is provided a positioning method, applied to an access network device, and including:
sending measurement configuration information, where the measurement configuration information is used by user equipment (UE) to determine time information of a global navigation satellite system (GNSS) measurement, and determine, according to an execution rule, whether to perform the GNSS measurement within a time range indicated by the time information.

According to a third aspect of the embodiments of the present disclosure, there is provided a communication device, including:
a processor; and
a memory, configured to store an executable instruction by the processor;
where the processor is configured to, when running the executable instruction, implement the positioning method according to the first aspect or the second aspect.

According to a fourth aspect of the embodiments of the present disclosure, there is provided a non-transitory computer storage medium, where the non-transitory computer storage medium stores a computer executable program, and when the executable program is executed by a processor, the positioning method according to the first aspect or the second aspect is implemented.

It is to be understood that both the foregoing general description and the following detailed description are exemplary and explanatory only and are not restrictive of the embodiments of the present disclosure.

### BRIEF DESCRIPTION OF THE DRAWINGS

The accompanying drawings, which are incorporated in and constitute a part of the description, illustrate embodiments consistent with the present disclosure and together with the description serve to explain the principles of the present disclosure.

FIG. 1 is a schematic structural diagram of a wireless communication system shown according to some embodiments of the present disclosure;

FIG. 2 is a schematic diagram of an uplink and downlink delay shown according to some embodiments of the present disclosure;

FIG. 3 is a schematic diagram of an uplink and downlink delay shown according to some embodiments of the present disclosure;

FIG. 4 is a schematic flowchart of a positioning method shown according to some embodiments of the present disclosure;

FIG. 5 is a schematic flowchart of a positioning method shown according to some embodiments of the present disclosure;

FIG. 6 is a schematic diagram of a relationship between a time window and a predetermined duration threshold shown according to some embodiments of the present disclosure;

FIG. 7 is a schematic flowchart of a positioning method shown according to some embodiments of the present disclosure;

FIG. 8 is a schematic flowchart of a positioning method shown according to some embodiments of the present disclosure;

FIG. 9 is a schematic diagram of feedback information shown according to some embodiments of the present disclosure;

FIG. 10 is a schematic flowchart of a positioning method shown according to some embodiments of the present disclosure;

FIG. 11 is a schematic flowchart of a positioning method shown according to some embodiments of the present disclosure;

FIG. 12 is a schematic flowchart of a positioning method shown according to some embodiments of the present disclosure;

FIG. 13 is a schematic flowchart of a positioning method shown according to some embodiments of the present disclosure;

FIG. 14 is a schematic flowchart of a positioning method shown according to some embodiments of the present disclosure;

FIG. 15 is a schematic flowchart of a positioning method shown according to some embodiments of the present disclosure;

FIG. 16 is a block diagram of a positioning apparatus shown according to some embodiments of the present disclosure;

FIG. 17 is a block diagram of a positioning apparatus shown according to some embodiments of the present disclosure;

FIG. 18 is a block diagram of UE shown according to some embodiments of the present disclosure;

FIG. 19 is a block diagram of a base station shown according to some embodiments of the present disclosure.

### DETAILED DESCRIPTION

Example embodiments will now be described in detail, examples of which are illustrated in the accompanying drawings. The following description refers to the accompanying drawings in which the same numbers in different drawings represent the same or similar elements unless otherwise represented. The implementations described in the following example embodiments do not represent all implementations consistent with the embodiments of the present disclosure. By contrast, they are merely examples of apparatuses and methods consistent with some aspects of the embodiments of the present disclosure as detailed in the appended claims.

The terms used in the embodiments of the present disclosure are merely for the purpose of describing particular embodiments, and are not intended to limit the embodiments of the present disclosure. The singular forms “a,” “the” and “said” used in the embodiments of the present disclosure and the appended claims are also intended to include plural forms, unless the context clearly indicates other meanings. It should also be understood that the term “and/or” as used here refers to and includes any or all possible combinations of one or more associated listed items.

It should be understood that although the terms “first,” “second,” “third,” or the like, may be used in the embodiments of the present disclosure to describe various information, these information should not be limited to these terms. These terms are only used to distinguish the same type of information from each other. For example, without departing from the scope of the embodiments of the present disclosure, the first information may also be referred to as second information, and similarly, the second information may also be referred to as first information. Depending on the context, the word “if” as used here may be interpreted as “at the time . . . ” “or” when . . . “or” “in response to determining . . . ”.

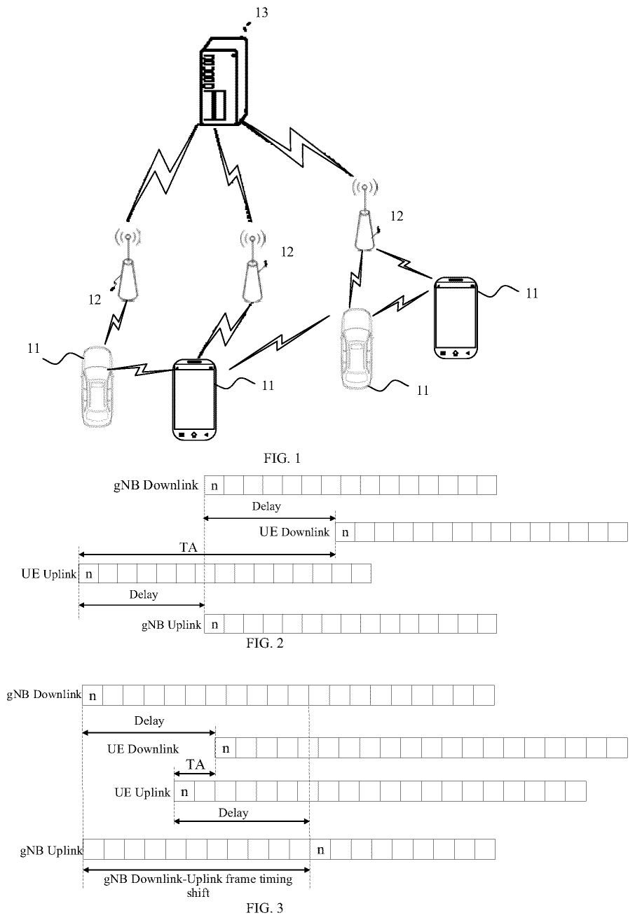

Referring to FIG. 1, it shows a schematic structural diagram of a wireless communication system provided according to some embodiments of the present disclosure. As shown in FIG. 1, the wireless communication system is a communication system based on cellular mobile communication technology, and the wireless communication system may include several terminals 11 and several base stations 12.

In some embodiments, the terminal 11 may be a device that provides voice and/or data connectivity to a user. The terminal 11 may communicate with one or more core network devices via a radio access network (RAN). The terminal 11 may be an Internet of Things (IoT) terminal, such as a sensor device, a mobile phone (or referred to as a “cellular” phone), and a computer having an IoT terminal. For example, the terminal 11 may be a fixed apparatus, a portable apparatus, a pocket-sized apparatus, a handheld apparatus, a computer-built-in apparatus, or a vehicle-mounted apparatus, such as a station (STA), a subscriber unit, a subscriber station, a mobile station, a mobile, a remote station, an access point, a remote terminal, an access terminal, a user terminal, a user agent, a user device, or user equipment (UE). In some embodiments, the terminal 11 may also be a device of an unmanned aerial vehicle. In some embodiments, the terminal 11 may also be a vehicle-mounted device, for example, may be a trip computer having a wireless communication function, or a wireless communication device externally connected to a trip computer. In some embodiments, the terminal 11 may also be an infrastructure, for example, may be a street lamp, a signal lamp, or another infrastructure having a wireless communication function, etc.

The base station 12 may be a network side device in the wireless communication system. In some embodiments, the wireless communication system may be the 4th generation mobile communication (4G) system, which is also referred to as the long term evolution (LTE) system. In some embodiments, the wireless communication system may also be the 5G system, which is also referred to as the new radio (NR) system, or the 5G NR system. In some embodiments, the wireless communication system may be a next-generation system of the 5G system. In some embodiments, the access network in the 5G system may be referred to as a new generation-radio access network (NG-RAN). In some embodiments, the wireless communication system may be an MTC system.

In some embodiments, the base station 12 may be an evolved Node B (eNB) used in the 4G system. In some embodiments, the base station 12 may also be a base station (gNB) adopting a centralized distributed architecture in the 5G system. When the base station 12 adopts a centralized distributed architecture, the base station 12 usually includes a central unit (CU) and at least two distributed units (DU). The centralized unit is provided with a protocol stack for a packet data convergence protocol (PDCP) layer, a radio link control (RLC) protocol layer, and a media access control (MAC) layer. The distributed unit is provided with a protocol stack for a physical (PHY) layer. The specific implementation of the base station 12 is not limited in the embodiments of the present disclosure.

A wireless connection may be established between the base station 12 and the terminal 11 through a wireless air interface. In different embodiments, the wireless air interface is a wireless air interface based on the 4th generation mobile communication network technology (4G) standard. In some embodiments, the wireless air interface is a wireless air interface based on the 5th generation mobile communication network technology (5G) standard, for example, the wireless air interface is a new radio. In some embodiments, the wireless air interface may also be a wireless air interface based on a next-generation mobile communication network technology standard of 5G.

In some embodiments, an end to end (E2E) connection may also be established between the terminals 11, for example, in the scenarios of a vehicle to vehicle (V2V) communication, a vehicle to infrastructure (V2I) communication, and a vehicle to pedestrian (V2P) communication in the vehicle to everything (V2X) communication.

In some embodiments, the wireless communication system may further include a network management device 13.

Several base stations 12 are respectively connected to the network management device 13. In some embodiments, the network management device 13 may be a core network device in the wireless communication system. For example, the network management device 13 may be a mobility management entity (MME) in an evolved packet core (EPC) network device. In some embodiments, the network management device may be another core network device, such as a serving gateway (SGW), a public data network gateway (PGW), a policy and charging rules function (PCRF), or a home subscriber server (HSS), etc. The implementation form of the network management device 13 is not limited in the embodiments of the present disclosure.

In order to facilitate the understanding of those skilled in the art, in the embodiments of the present disclosure, a plurality of embodiments are listed to clearly illustrate the technical solutions of the embodiments of the present disclosure. Certainly, those skilled in the art may understand that the plurality of embodiments provided in the embodiments of the present disclosure may be separately performed, or may be performed after being combined with the methods of other embodiments in the embodiments of the present disclosure, or may be performed separately or in combination with some methods in other related technologies, which is not limited in the embodiments of the present disclosure.

In a scenario of satellite communication, since there is a relatively longer signal transmission distance between the signal sending end and the signal receiving end, the data transmission needs a relatively longer time. For transmission in which there is an uplink and downlink relationship, in the current standardized discussion, it is determined to introduce an offset parameter Koffset to compensate for the transmission delay in the satellite communication scenario. Generally, in the scenario of satellite communication, data transmission may be implemented in the manner of uplink and downlink timing alignment on the base station side shown in FIG. 2 and in the manner of uplink and downlink timing misalignment on the base station side shown in FIG. 3.

The Koffset may be applied to a plurality of operations, for example, PUSCH transmission scheduled by DCI, transmission of HARQ feedback information, transmission of MAC CE, or the like.

In the scenario of satellite communication, the UE needs to obtain its own position information to facilitate uplink synchronization compensation, and the UE may determine the position information of the UE by performing a GNSS measurement.

For the IoT UE, it is not currently supported that a cellular mobile communication (Cellular) module and a GNSS module work simultaneously; that is, the cellular mobile communication and the GNSS measurement cannot be performed simultaneously.

For the IoT UE, the duration of performing the GNSS measurement and positioning (GNSS position fix) by the UE is determined by the UE itself, and the duration is related to the hardware condition of the terminal, the channel environment, the moving speed, or the like.

The base station may trigger the UE to perform GNSS measurement. However, since the base station does not know that the GNSS state information of the UE cannot be obtained in time, trigger of the base station or periodic configuration may not match the GNSS state of the UE, and the UE may perform invalid GNSS measurement, resulting in power consumption.

Therefore, how to reduce the invalid GNSS measurement and reduce the power consumption is an urgent problem to be solved.

In view of this, according to embodiments of the present disclosure, there is provided a positioning method and apparatus, a communication device, and a storage medium.

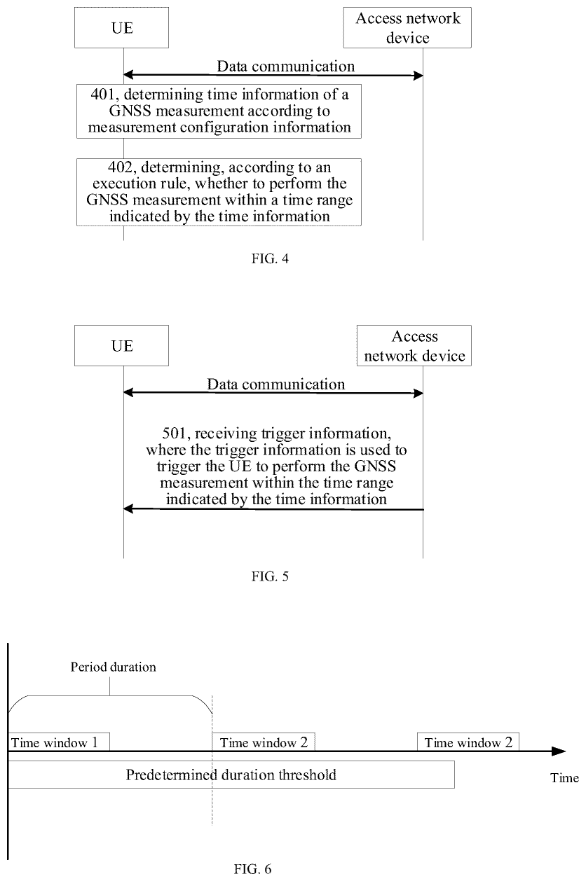

As shown in FIG. 4, according to some embodiments, there is provided a positioning method, which may be performed by UE and include following steps.

In step 401, time information of a GNSS measurement is determined according to measurement configuration information.

In step 402, it is determined, according to an execution rule, whether to perform the GNSS measurement within a time range indicated by the time information.

In some embodiments, the UE may include UE that cannot perform the cellular mobile communication and the GNSS measurement simultaneously.

The UE may be NB-IoT UE, eMTC UE, or RedCap UE.

The UE may obtain the measurement configuration information through one of the following manners.

The measurement configuration information is specified in a communication protocol.

The measurement configuration information is pre-stored in the UE.

The measurement configuration information is received from a network side device such as an access network device.

The measurement configuration information may include, but is not limited to, time information of the GNSS measurement. For example, the measurement configuration information may include indication information that indicates the satellite navigation system used by the UE.

In some embodiments, the method further includes:
receiving the measurement configuration information.

Here, the access network device may indicate, by using the measurement configuration information, the time range for performing the GNSS measurement to the UE.

In some embodiments, the access network device includes, but is not limited to, a base station in a ground network.

In some embodiments, the access network device includes, but is not limited to, a base station or a satellite in a non-terrestrial network (NTN).

The measurement configuration information may be determined by the core network device, and transmitted to the UE by using the access network device.

In some embodiments, the measurement configuration information is carried in:
radio resource control (RRC) signaling; or
a medium access control control unit (MAC CE); or
physical layer signaling.

Performing the GNSS measurement by the UE may include determining position information of the UE by using the satellite navigation system.

In some embodiments, the time range indicated by the time information includes, but is not limited to, at least one of the following:
a time window for performing the GNSS measurement; or
a period of performing the GNSS measurement.

In some embodiments, determining, according to the execution rule, whether to perform the GNSS measurement within the time range indicated by the time information includes:
determining, according to the execution rule, whether to perform the GNSS measurement in the current time window. Here, the current time window may be a time window closest to the current moment after the current moment.

The execution rule may be a rule for determining whether to perform the GNSS measurement.

In some embodiments, the execution rule may be determined according to a requirement of the UE on the position information.

For example, if the UE does not need to determine its own position information within the predetermined duration, the UE may not perform the GNSS measurement within the time range indicated by the time information.

For another example, if the UE has determined the position information, and the UE determines that the position information is valid within the predetermined duration, the UE does not perform the GNSS measurement. Here, the position information may be determined by the UE through at least one of the following: through the positioning of the base station, and/or through the positioning manner between UE, and/or through historical GNSS measurements. Determining, by the UE, that the position information is valid within the predetermined duration, may include, but is not limited to, at least one of the following: the UE does not move within the predetermined duration; or, it is determined, based on the movement speed of the UE, that the position information of the UE is valid within the predetermined duration.

In this way, the UE may determine, according to the execution rule, whether to perform the GNSS measurement within the time range configured by the measurement configuration information, and no longer perform all GNSS measurements within the time range configured by the measurement configuration information. On the one hand, the flexibility of performing GNSS measurement is improved. On the other hand, invalid GNSS measurements may be reduced, and power consumption may be reduced, which is an urgent problem to be solved.

As shown in FIG. 5, according to some embodiments, there is provided a positioning method, which may be performed by a UE and include the following step.

In step 501, trigger information is received, where the trigger information is used to trigger the UE to perform the GNSS measurement within the time range indicated by the time information.

In some embodiments, the UE receives the measurement configuration information sent by the access network device. The UE may perform, according to the measurement configuration information, the GNSS measurement within the time range indicated by the time information. Here, before the GNSS measurement is performed within the time range indicated by the time information, it is needed to determine, according to the execution rule, whether to perform the GNSS measurement.

In some embodiments, the access network device may send the trigger information to make the measurement configuration information valid. That is, the UE is triggered, by the trigger information, to perform the GNSS measurement within the time range indicated by the time information according to the measurement configuration information. Here, for the triggered and performed GNSS measurement, it is also needed to determine, according to the execution rule, whether to perform the GNSS measurement.

In some embodiments, the trigger information is used to trigger the UE to perform the GNSS measurement in a time window, where the time window includes a current time window. Here, the current time window may be a time window closest to the current moment after the current moment.

In some embodiments, determining, according to the execution rule, whether to perform the GNSS measurement within the time range indicated by the time information includes:
in response to determining that an available duration of current GNSS position information of the UE is greater than a predetermined duration threshold, not performing the GNSS measurement; or
in response to determining that the available duration is less than or equal to the predetermined duration threshold, performing the GNSS measurement.

In some embodiments, the GNSS position information of the UE may be used to determine a timing shift between the terminal and the network side device.

Here, the time range indicated by the time information may include a closest time window for performing GNSS measurement indicated by the time information.

In some embodiments, not performing the GNSS measurement includes not performing the GNSS measurement in the current time window. Here, the current time window may be a time window closest to the current moment after the current moment.

The current GNSS position information may be determined by the UE through at least one of the following: through the positioning of the base station, and/or through positioning manner between UE, and/or through historical GNSS measurements.

The GNSS position information (GNSS position fix) obtained by the UE has an available duration, and the validity of the GNSS position information may only be maintained for a period of time. After the available duration is exceeded, the GNSS position information of the terminal device is outdated, and the UE needs to re-obtain the GNSS position information.

The predetermined duration threshold may be determined based on the frequency at which the UE requires the GNSS position information and/or the UE performs the GNSS measurement.

For example, when the UE is stationary within the available duration, the UE may not need to perform the GNSS measurement again. The predetermined duration threshold may be determined based on a stationary duration of the UE.

For another example, as shown in FIG. 6, when the UE is required to perform a plurality of GNSS measurements within the available duration, and the time range (including the time window) of the plurality of GNSS measurements is located within the available duration, it is obvious that these GNSS measurements are invalid. Therefore, the UE may not perform one or more GNSS measurements of these GNSS measurements. The predetermined duration threshold may be set based on the GNSS measurement frequency of the UE.

In some embodiments, the predetermined duration threshold is greater than or equal to a measurement period duration of the GNSS measurement, where the time range indicated by the time information includes the measurement period duration.

In some embodiments, the measurement period duration includes a period duration of a time window for the GNSS measurement indicated by the measurement configuration information.

In some embodiments, the measurement period duration may be indicated by time information. That is, the time range indicated by the time information includes the measurement period duration.

In some embodiments, the measurement period duration may be determined based on the time range indicated by the time information. For example, the time range indicated by the time information includes a plurality of time windows, and the UE may determine the period duration of the time window based on the time windows.

For example, as shown in FIG. 6, the predetermined duration threshold is greater than or equal to the measurement period duration of the GNSS measurement. That is, there may be a plurality of GNSS measurements within the available duration of the current GNSS position information, and at least one GNSS measurement of the plurality of GNSS measurements is an unnecessary measurement. Therefore, when the available duration of the current GNSS position information is greater than the predetermined duration threshold, the UE may determine not to perform the current GNSS measurement.

In some embodiments, in response to the predetermined duration threshold being greater than or equal to N times the measurement period duration, and when the available duration of the current GNSS position information is greater than the predetermined duration threshold, the UE determines not to perform GNSS measurement in N−1 time windows.

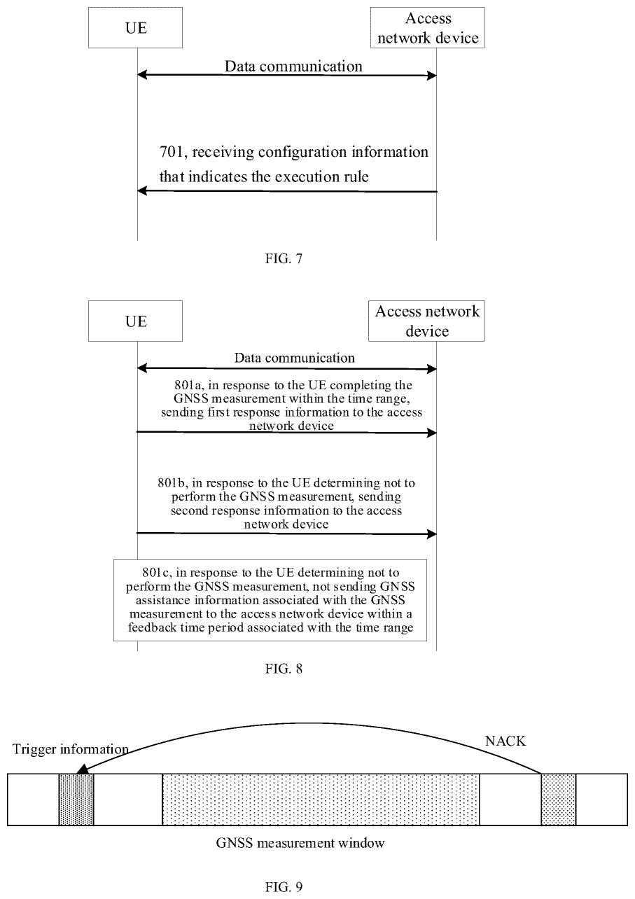

As shown in FIG. 7, according to some embodiments, there is provided a positioning method, which may be performed by UE and include the following step.

In step 701, configuration information that indicates the execution rule is received.

In some embodiments, the execution rule is predefined.

In some embodiments, the configuration information that indicates the execution rule may be determined by the access network device and/or the core network device, and sent to the UE by using the access network device.

In some embodiments, the execution rule is predefined. Here, being predefined may include one of the following:
being specified in a communication protocol; or
being agreed upon by the UE and the network side device such as the access network device and/or the core network device.

In some embodiments, the UE may receive the execution rule from the access network device, and the execution rule indicates whether the available duration of the GNSS position information exceeds the predetermined duration threshold. When the UE determines that the available duration of its GNSS position information exceeds the predetermined duration threshold, the UE ignores the GNSS measurement operation in the present GNSS measurement time window. Otherwise, the UE performs the GNSS measurement operation in the present GNSS measurement window.

In some embodiments, the execution rule is predefined, and the execution rule indicates whether the available duration of the GNSS position information exceeds the predetermined duration threshold. When the UE determines that the available duration of its GNSS position information exceeds the predetermined duration threshold, the UE ignores the GNSS measurement operation in the present GNSS measurement time window. Otherwise, the UE performs the GNSS measurement operation in the present GNSS measurement window.

As shown in FIG. 8, according to some embodiments, there is provided a positioning method, which may be performed by a UE and include following steps.

In step 801a, in response to the UE completing the GNSS measurement within the time range, first response information is sent to the access network device.

In step 801b, in response to the UE determining not to perform the GNSS measurement, second response information is sent to the access network device.

In step 801c, in response to the UE determining not to perform the GNSS measurement, GNSS assistance information associated with the GNSS measurement is not sent to the access network device within a feedback time period associated with the time range.

In some embodiments, the UE receives the trigger information from the access network device to determine to perform the GNSS measurement. When the UE performs the present GNSS measurement based on the execution rule, the UE feeds back HARQ feedback information for the trigger instruction. For example, “ACK” may be used for the first response information to represent that the present GNSS measurement is performed.

In some embodiments, the first response information may include GNSS assistance information. The GNSS assistance information may include, but is not limited to, at least one of the following: position information determined by performing the GNSS measurement, or indication information that indicates the available duration of the position information.

As shown in FIG. 9, when the UE does not perform the present GNSS measurement based on the execution rule, the UE may feed back the second response information. For example, “NACK” may be used by the second response information to represent that the present GNSS measurement is not performed. When the access network device receives the “NACK” feedback for the trigger instruction, the access network device determines that the UE does not perform the present GNSS measurement.

In some embodiments, the UE does not perform the present GNSS measurement based on the execution rule, and the UE does not feed back the GNSS assistance information within a predefined feedback time period after the GNSS measurement time window ends. When no GNSS assistance information sent by the UE is received within the predefined feedback time period of the access network device, the access network device determines that the UE does not perform the present GNSS measurement.

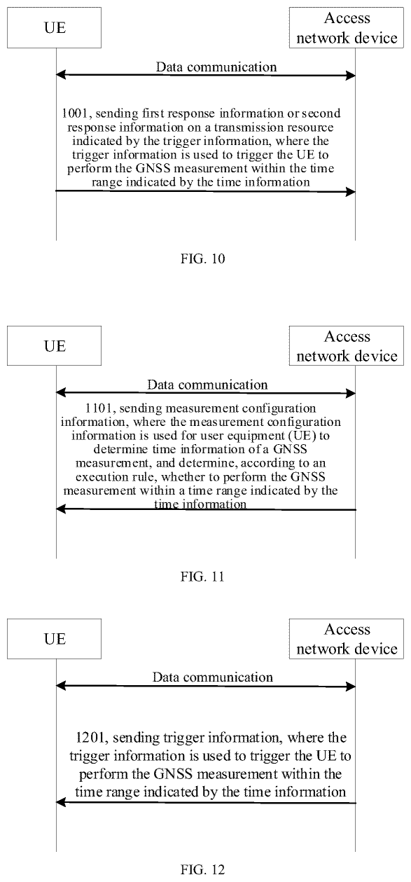

As shown in FIG. 10, according to some embodiments, there is provided a positioning method, which may be performed by UE and includes at least one of the following step.

In step 1001, first response information or second response information is sent on a transmission resource indicated by the trigger information, where the trigger information is used to trigger the UE to perform the GNSS measurement within the time range indicated by the time information.

In a possible embodiment, the trigger information used to indicate the transmission resource for the first response information or the second response information and the trigger information used to trigger the UE to perform the GNSS measurement within the time range indicated by the time information may be the same trigger information.

Here, the transmission resource for the first response information and/or the second response information may be indicated by using the trigger information. As shown in FIG. 9, the trigger information indicates the transmission resource for the first response information and/or the second response information while triggering the UE to perform the GNSS measurement. The base station may receive the first response information and/or the second response information on the transmission resource indicated by the trigger information, and correspond the first response information and/or the second response information to the performed GNSS measurement.

In some embodiments, the measurement configuration information may also be used to indicate the transmission resource for the first response information and/or the second response information.

As shown in FIG. 11, according to some embodiments, there is provided a positioning method, which may be performed by an access network device and include the following step.

In step 1101, measurement configuration information is sent, where the measurement configuration information is used by user equipment (UE) to determine time information of a GNSS measurement, and determine, according to an execution rule, whether to perform the GNSS measurement within a time range indicated by the time information.

In some embodiments, the UE may include UE that cannot perform the cellular mobile communication and the GNSS measurement simultaneously.

The UE may be NB-IoT UE, eMTC UE, or RedCap UE.

The UE may obtain the measurement configuration information through one of the following manners.

The measurement configuration information is specified in a communication protocol.

The measurement configuration information is pre-stored in the UE.

The measurement configuration information is received from a network side device such as the access network device.

The measurement configuration information may include, but is not limited to, time information of the GNSS measurement. For example, the measurement configuration information may include indication information that indicates the satellite navigation system used by the UE.

Herein, the access network device may indicate, by using the measurement configuration information, the time range for performing the GNSS measurement to the UE.

In some embodiments, the access network device includes, but is not limited to, a base station in a ground network.

In some embodiments, the access network device includes, but is not limited to, a base station or a satellite in a NTN network.

The measurement configuration information may be determined by the core network device, and transmitted to the UE by using the access network device.

In some embodiments, the measurement configuration information is carried in:
radio resource control (RRC) signaling; or
a medium access control control unit (MAC CE); or
physical layer signaling.

Performing the GNSS measurement by the UE may include determining position information of the UE by using the satellite navigation system.

In some embodiments, the time range indicated by the time information includes, but is not limited to, at least one of the following:
a time window for performing the GNSS measurement; or
a period of performing the GNSS measurement.

In some embodiments, determining, according to the execution rule, whether to perform the GNSS measurement within the time range indicated by the time information includes:
determining, according to the execution rule, whether to perform the GNSS measurement in the current time window. Here, the current time window may be a time window closest to the current moment after the current moment.

The execution rule may be a rule for determining whether to perform the GNSS measurement.

In some embodiments, the execution rule may be determined according to a requirement of the UE on the position information.

For example, if the UE does not need to determine its own position information within the predetermined duration, the UE may not perform the GNSS measurement within the time range indicated by the time information.

For another example, if the UE has determined the position information, and the UE determines that the position information is valid within the predetermined duration, the UE does not perform the GNSS measurement. Here, the position information may be determined by the UE through at least one of the following: through the positioning of the base station, and/or through the positioning manner between UE, and/or through historical GNSS measurements. Determining, by the UE, that the position information is valid within the predetermined duration, may include, but is not limited to, at least one of the following: the UE does not move within the predetermined duration; or, it is determined, based on the movement speed of the UE, that the position information of the UE is valid within the predetermined duration.

In this way, the UE may determine, according to the execution rule, whether to perform the GNSS measurement within the time range configured by the measurement configuration information, and no longer perform all GNSS measurements within the time range configured by the measurement configuration information. On the one hand, the flexibility of performing GNSS measurement is improved. On the other hand, invalid GNSS measurements may be reduced, and power consumption may be reduced, which is an urgent problem to be solved.

As shown in FIG. 12, according to some embodiments, there is provided a positioning method, which may be performed by an access network device and include the following step.

In step 1201, trigger information is sent, where the trigger information is used to trigger the UE to perform the GNSS measurement within the time range indicated by the time information.

In some embodiments, the UE receives the measurement configuration information sent by the access network device. The UE may perform, according to the measurement configuration information, the GNSS measurement within the time range indicated by the time information. Here, before the GNSS measurement is performed within the time range indicated by the time information, it is needed to determine, according to the execution rule, whether to perform the GNSS measurement.

In some embodiments, the access network device may send the trigger information to make the measurement configuration information valid. That is, the UE is triggered, by the trigger information, to perform the GNSS measurement within the time range indicated by the time information according to the measurement configuration information. Here, for the triggered and performed GNSS measurement, it is also needed to determine, according to the execution rule, whether to perform the GNSS measurement.

In some embodiments, the trigger information is used to trigger the UE to perform the GNSS measurement in a time window, where the time window includes a current time window. Here, the current time window may be a time window closest to the current moment after the current moment.

In some embodiments, the execution rule includes:
in response to determining that an available duration of current GNSS position information of the UE is greater than a predetermined duration threshold, not performing the GNSS measurement by the UE; or
in response to determining that the available duration is less than or equal to the predetermined duration threshold, performing the GNSS measurement by the UE.

In some embodiments, the GNSS position information of the UE may be used to determine a timing shift between the terminal and the network side device.

Here, the time range indicated by the time information may include a closest time window for performing the GNSS measurement indicated by the time information.

In some embodiments, not performing the GNSS measurement includes not performing the GNSS measurement in the current time window. Here, the current time window may be a time window closest to the current moment after the current moment.

The current GNSS position information may be determined by the UE through at least one of the following: through the positioning of the base station, and/or through positioning manner between UE, and/or through historical GNSS measurements.

The GNSS position information (GNSS position fix) obtained by the UE has an available duration, and the validity of the GNSS position information may only be maintained for a period of time. After the available duration is exceeded, the GNSS position information of the terminal device is outdated, and the UE needs to re-obtain the GNSS position information.

The predetermined duration threshold may be determined based on the GNSS position information required by the UE and/or the frequency at which the UE performs the GNSS measurement.

For example, when the UE is stationary within the available duration, the UE may not need to perform the GNSS measurement again. The predetermined duration threshold may be determined based on a stationary duration of the UE.

For another example, as shown in FIG. 6, when the UE is required to perform a plurality of GNSS measurements within the available duration, and the time range (including the time window) of the plurality of GNSS measurements is located within the available duration, it is obvious that these GNSS measurements are invalid. Therefore, the UE may not perform one or more GNSS measurements of these GNSS measurements. The predetermined duration threshold may be set based on the GNSS measurement frequency of the UE.

In some embodiments, the predetermined duration threshold is greater than or equal to a measurement period duration of the GNSS measurement, where the time range indicated by the time information includes the measurement period duration.

In some embodiments, the measurement period duration includes a period duration of a time window for the GNSS measurement indicated by the measurement configuration information.

In some embodiments, the measurement period duration may be indicated by time information. That is, the time range indicated by the time information includes the measurement period duration.

In some embodiments, the measurement period duration may be determined based on the time range indicated by the time information. For example, the time range indicated by the time information includes a plurality of time windows, and the UE may determine the period duration of the time window based on the time windows.

For example, as shown in FIG. 6, the predetermined duration threshold is greater than or equal to the measurement period duration of the GNSS measurement. That is, there may be a plurality of GNSS measurements within the available duration of the current GNSS position information, and at least one GNSS measurement of the plurality of GNSS measurements is an unnecessary measurement. Therefore, when the available duration of the current GNSS position information is greater than the predetermined duration threshold, the UE may determine not to perform the current GNSS measurement.

In some embodiments, in response to the predetermined duration threshold being greater than or equal to N times the measurement period duration, and when the available duration of the current GNSS position information is greater than the predetermined duration threshold, the UE determines not to perform GNSS measurement in N−1 time windows.

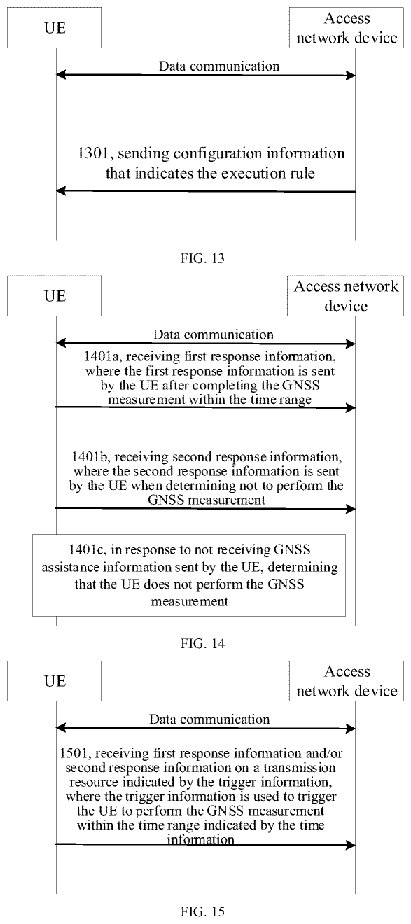

As shown in FIG. 13, according to some embodiments, there is provided a positioning method, which may be performed by an access network device and the following step.

In step 1301, configuration information that indicates the execution rule is sent.

In some embodiments, the execution rules are predefined.

In some embodiments, the configuration information that indicates the execution rule may be determined by the access network device and/or the core network device, and sent to the UE by using the access network device.

In some embodiments, the execution rule is predefined. Here, being predefined may include one of the following:
being specified in a communication protocol; or
being agreed upon by the UE and the network side device such as the access network device and/or the core network device.

In some embodiments, the UE may receive the execution rule from the access network device, and the execution rule indicates whether the available duration of the GNSS position information exceeds the predetermined duration threshold. When the UE determines that the available duration of its GNSS position information exceeds the predetermined duration threshold, the UE ignores the GNSS measurement operation in the present GNSS measurement time window. Otherwise, the UE performs the GNSS measurement operation in the present GNSS measurement window.

In some embodiments, the execution rule is predefined, and the execution rule indicates whether the available duration of the GNSS position information exceeds the predetermined duration threshold. When the UE determines that the available duration of its GNSS position information exceeds the predetermined duration threshold, the UE ignores the GNSS measurement operation in the present GNSS measurement time window. Otherwise, the UE performs the GNSS measurement operation in the present GNSS measurement window.

As shown in FIG. 14, according to some embodiments, there is provided a positioning method, which may be performed by an access network device and include following steps.

In step 1401a, first response information is received, where the first response information is sent by the UE after completing the GNSS measurement within the time range; or
In step 1401b, second response information is received, where the second response information is sent by the UE when determining not to perform the GNSS measurement; or
In step 1401c, in response to not receiving GNSS assistance information sent by the UE, it is determined that the UE does not perform the GNSS measurement.

When the UE performs the present GNSS measurement based on the execution rule, the UE feeds back HARQ feedback information for the trigger instruction. For example, “ACK” may be used by the first response information to represent that the present GNSS measurement is performed.

In some embodiments, the first response information may include GNSS assistance information. The GNSS assistance information may include, but is not limited to, at least one of the following: position information determined by performing the GNSS measurement, or indication information that indicates the available duration of the position information.

As shown in FIG. 9, when the UE does not perform the present GNSS measurement based on the execution rule, the UE may feed back the second response information. For example, “NACK” may be used by the second response information to represent that the present GNSS measurement is not performed. When the access network device receives the “NACK” feedback for the trigger instruction, the access network device determines that the UE does not perform the present GNSS measurement.

In some embodiments, the UE does not perform the present GNSS measurement based on the execution rule, and the UE does not feed back the GNSS assistance information within a predefined feedback time period after the GNSS measurement time window ends. When no GNSS assistance information sent by the UE is received within the predefined feedback time period of the access network device, the access network device determines that the UE does not perform the present GNSS measurement.

As shown in FIG. 15, according to some embodiments, there is provided a positioning method, which may be performed by an access network device and includes at least one of the following step.

In step 1501, first response information and/or second response information are received on a transmission resource indicated by the trigger information, where the trigger information is used to trigger the UE to perform the GNSS measurement within the time range indicated by the time information.

In a possible embodiment, the trigger information used to indicate the transmission resource for the first response information or the second response information and the trigger information used to trigger the UE to perform the GNSS measurement within the time range indicated by the time information may be the same trigger information.

Here, the transmission resource for the first response information and/or the second response information may be indicated by using the trigger information. As shown in FIG. 9, the trigger information indicates the transmission resource for the first response information and/or the second response information while triggering the UE to perform the GNSS measurement. The base station may receive the first response information and/or the second response information on the transmission resource indicated by the trigger information, and correspond the first response information and/or the second response information to the performed GNSS measurement.

In some embodiments, the measurement configuration information may also be used to indicate the transmission resource for the first response information and/or the second response information.

In combination of any of the foregoing embodiments, there is provided a specific example below.

In the present example, there is provided a method, applied to a satellite communication system, for a terminal to skip GNSS measurement, in which the terminal is prevented from performing useless GNSS measurements, and power consumption of the terminal may be effectively reduced.

1. The terminal receives the measurement configuration information from the base station to determine the configuration of the GNSS measurement.
a) The measurement configuration information includes time window information for the terminal to perform the GNSS measurement, and the terminal performs the GNSS measurement within the time window.
b) The configuration information may be carried by RRC signaling, a MAC CE, or physical layer signaling.

2. The terminal determines to skip the GNSS measurement.
a) When the terminal determines, based on the configuration information, that the GNSS measurement needs to be performed, the terminal determines, based on the execution rule (which is predefined or configured by the base station), whether to perform the GNSS measurement operation within the present GNSS measurement window.

In some embodiments, the terminal may receive an execution rule configured by the base station, where the execution rule is as follows. It is determined whether the remaining available time of the GNSS position information exceeds a predetermined duration threshold (which is pre-configured or predefined). When the terminal determines that the available time of its GNSS position information exceeds the predetermined duration threshold, the terminal ignores the GNSS measurement operation in the present GNSS measurement window. Otherwise, the terminal performs the GNSS measurement operation in the present GNSS measurement time window.

In some embodiments, the terminal may be based on a predefined execution rule. The execution rule is as follows. It is determined whether the remaining available time of the GNSS position information exceeds a predetermined duration threshold (which is pre-configured or predefined). When the terminal determines that the available time of its GNSS position information exceeds the predetermined duration threshold, the terminal ignores the GNSS measurement operation in the present GNSS measurement window. Otherwise, the terminal performs the GNSS measurement operation in the present GNSS measurement time window.

3. The terminal reports indication information.
a) The terminal reports the indication information, where the indication information is used to indicate that the terminal skips the GNSS measurement.

In some embodiments, as shown in FIG. 9, the terminal receives a trigger instruction from the base station to determine to perform the GNSS measurement. When the terminal ignores the GNSS measurement based on the foregoing description, the terminal feeds back HARQ feedback information for the trigger instruction, such as “ACK” in the feedback information. That is, the first response information indicates that the present GNSS measurement is performed. “NACK,” i.e., the second response information, indicates that the present GNSS measurement is not performed. When the base station receives the “NACK” feedback for the trigger instruction, the base station determines that the terminal does not perform the GNSS measurement.

In another implementation method, the terminal ignores the present GNSS measurement based on the foregoing description, and the terminal does not feed back the GNSS assistance information within a predefined time (within a feedback period) after the GNSS measurement time window ends. When the base station does not receive the GNSS assistance information sent by the terminal within the predefined time (within the feedback period), the base station determines that the terminal does not perform present the GNSS measurement

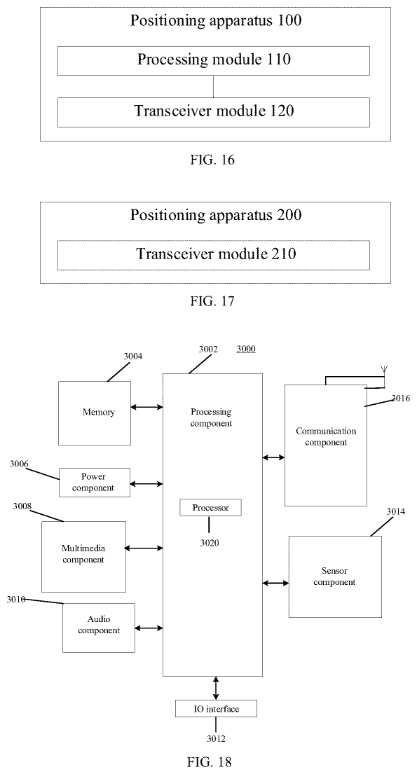

As shown in FIG. 16, according to some embodiments, there is provided a positioning apparatus 110, where the positioning apparatus 110 is applied in user equipment (UE) and includes a processing module 110.

The processing module 110 is configured to determine time information of a global navigation satellite system (GNSS) measurement according to measurement configuration information.

The processing module is further configured to determine, according to an execution rule, whether to perform the GNSS measurement within a time range indicated by the time information.

In some embodiments, the processing module is specifically configured to:
in response to determining that an available duration of current GNSS position information of the UE is greater than a predetermined duration threshold, not perform the GNSS measurement; or
in response to determining that the available duration is less than or equal to the predetermined duration threshold, perform the GNSS measurement.

In some embodiments, the predetermined duration threshold is greater than or equal to a measurement period duration of the GNSS measurement, and the time range indicated by the time information includes the measurement period duration.

In some embodiments, the apparatus further includes a transceiver module 120 configured to:
in response to the UE completing the GNSS measurement within the time range, send first response information to an access network device; or
in response to the UE determining not to perform the GNSS measurement, send second response information to the access network device; or
in response to the UE determining not to perform the GNSS measurement, not send GNSS assistance information associated with the GNSS measurement to the access network device within a feedback time period associated with the time range.

In some embodiments, the transceiver module is further configured to send the first response information or the second response information on a transmission resource indicated by trigger information, where the trigger information is used to trigger the UE to perform the GNSS measurement within the time range indicated by the time information.

In some embodiments, the transceiver module is further configured to receive configuration information that indicates the execution rule.

In some embodiments, the execution rule is predefined.

In some embodiments, the transceiver module is further configured to receive trigger information, where the trigger information is used to trigger the UE to perform the GNSS measurement within the time range indicated by the time information.

In some embodiments, the transceiver module is further configured to receive the measurement configuration information.

In some embodiments, the measurement configuration information is carried in:
radio resource control (RRC) signaling; or
a medium access control control unit (MAC CE); or
physical layer signaling.

As shown in FIG. 17, according to some embodiments, there is provided a positioning apparatus 200, where the positioning apparatus 200 is applied to an access network device and includes a transceiver module 210.

The transceiver module 210 is configured to send measurement configuration information, where the measurement configuration information is used by user equipment (UE) to determine time information of a global navigation satellite system (GNSS) measurement, and determine, according to an execution rule, whether to perform the GNSS measurement within a time range indicated by the time information.

In some embodiments, the execution rule includes:
in response to determining that an available duration of current GNSS position information of the UE is greater than a predetermined duration threshold, the UE does not perform the GNSS measurement; or
in response to determining that the available duration is less than or equal to the predetermined duration threshold, the UE performs the GNSS measurement.

In some embodiments, the predetermined duration threshold is greater than or equal to a measurement period duration of the GNSS measurement, and the time range indicated by the time information includes the measurement period duration.

In some embodiments, the transceiver module is further configured to:
receive first response information, where the first response information is sent by the UE after completing the GNSS measurement within the time range; or
receive second response information, where the second response information is sent by the UE when determining not to perform the GNSS measurement; or
in response to not receiving GNSS assistance information sent by the UE, determining that the UE does not perform the GNSS measurement.

In some embodiments, the transceiver module is further configured to:
receive the first response information and/or the second response information on a transmission resource indicated by the trigger information, where the trigger information is used to trigger the UE to perform the GNSS measurement within the time range indicated by the time information.

In some embodiments, the transceiver module is further configured to:
send configuration information that indicates the execution rule.

In some embodiments, the execution rules are predefined.

In some embodiments, the transceiver module is further configured to:
send trigger information, where the trigger information is used to trigger the UE to perform the GNSS measurement within the time range indicated by the time information.

In some embodiments, the measurement configuration information is carried in:
radio resource control (RRC) signaling; or
a medium access control control unit (MAC CE); or
physical layer signaling.

According to some embodiments of the present disclosure, there is provided a communication device, including:
a processor; and
a memory, configured to store an executable instruction by the processor;
where the processor is configured to, when running the executable instruction, implement the positioning method according to any embodiment of the present disclosure.

In some embodiments, the communication device may include, but is not limited to, at least one of UE or a network device. The network device may include a core network device, an access network device, or the like. Here, the access network device may include a base station, and the core network device may include an AMF and an SMF.

In some embodiments, the processor may include various types of storage medium. The storage medium is a non-transitory computer storage medium. After the user equipment is powered down, the information stored on the non-transitory computer storage medium can be continued to be memorized.

The processor may be connected to the memory by using a bus or the like, and is configured to read an executable program stored in the memory, for example, at least one of the methods shown in FIG. 2, FIG. 5, FIG. 7 to FIG. 8, and FIG. 10 to FIG. 15.

According to some embodiments of the present disclosure, there is further provided a computer storage medium, where the computer storage medium stores a computer executable program. When the executable program is executed by the processor, the positioning method according to any embodiment of the present disclosure is implemented, for example, at least one of the methods shown in FIG. 2, FIG. 5, FIG. 7 to FIG. 8, and FIG. 10 to FIG. 15.

With regard to the apparatus or the storage medium in the above embodiments, the specific manner in which the modules perform operations has been described in detail in the embodiments related to the method, which will not be described in detail here.

FIG. 18 is a block diagram of user equipment 3000 shown according to some embodiments of the present disclosure. For example, the user equipment 3000 may be a mobile phone, a computer, digital broadcast user equipment, a message transceiver, a game console, a tablet device, a medical device, a fitness device, a personal digital assistant, or the like.

Referring to FIG. 18, the user equipment 3000 may include one or more of the following components: a processing component 3002, a memory 3004, a power component 3006, a multimedia component 3008, an audio component 3010, an input/output (I/O) interface 3012, a sensor component 3014, and a communication component 3016.

The processing component 3002 typically controls overall operations of the user equipment 3000, such as operations associated with display, telephone calls, data communications, camera operations, and recording operations. The processing component 3002 may include one or more processors 3020 to execute instructions to perform all or part of the steps in the foregoing methods. In addition, the processing component 3002 may include one or more modules which facilitate the interaction between the processing component 3002 and other components. For example, the processing component 3002 may include a multimedia module to facilitate interaction between the multimedia component 3008 and the processing component 3002.

The memory 3004 is configured to store various types of data to support the operations of the user equipment 3000. Examples of such data include instructions for any application or method operating on user equipment 3000, contact data, phonebook data, messages, pictures, videos, etc. The memory 3004 may be implemented by any type of volatile or non-volatile storage device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 3006 provides power for various components of the user equipment 3000. The power component 3006 may include a power management system, one or more power supplies, and other components associated with generating, managing, and distributing power for the user equipment 3000.

The multimedia component 3008 includes a screen providing an output interface between the user equipment 3000 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touching, sliding, and gestures on the touch panel. The touch sensor may not only sense a boundary of a touching or sliding action, but also detect a duration and pressure associated with the touching or sliding action. In some embodiments, the multimedia component 3008 includes a front camera and/or a rear camera. When the user equipment 3000 is in an operation mode, such as a photographing mode or a video mode, the front camera and/or the rear camera may receive external multimedia data. Each of the front camera and the rear camera may be a fixed optical lens system or have focal length and optical zoom capability.

The audio component 3010 is configured to output and/or input audio signals. For example, the audio component 3010 includes a microphone (MIC) configured to receive an external audio signal when the user equipment 3000 is in an operation mode, such as a call mode, a recording mode, and a voice recognition mode. The received audio signal may be further stored in the memory 3004 or transmitted via the communication component 3016. In some embodiments, the audio component 3010 further includes a speaker to output audio signals.

The I/O interface 3012 provides an interface between the processing component 3002 and the peripheral interface module, and the peripheral interface module may be a keyboard, a click wheel, a button, or the like. The button may include, but is not limited to, a home button, a volume button, a starting button, and a locking button.

The sensor component 3014 includes one or more sensors to provide state assessments of various aspects of the user equipment 3000. For example, the sensor component 3014 may detect an on/off state of the equipment 3000, and relative positioning of the components, for example, the components are a display and a keypad of the user equipment 3000. The sensor component 3014 may also detect a position change of one component of the user equipment 3000 or the user equipment 3000, presence or absence of contact by the user with the user equipment 3000, orientation or acceleration/deceleration of the user equipment 3000, and a temperature change of the user equipment 3000. The sensor component 3014 may include a proximity sensor configured to detect the presence of nearby objects without any physical contact. The sensor component 3014 may also include an optical sensor, such as a CMOS or CCD image sensor, for use in imaging applications. In some embodiments, the sensor component 3014 may further include an acceleration sensor, a gyroscope sensor, a magnetic sensor, a pressure sensor, or a temperature sensor.

The communication component 3016 is configured to facilitate wired or wireless communication between the user equipment 3000 and other devices. The user equipment 3000 may access a wireless network based on a communication standard, such as WiFi, 4G, or 5G, or a combination of them. In some embodiments, the communication component 3016 receives a broadcast signal or broadcast related information from an external broadcast management system via a broadcast channel. In some embodiments, the communication component 3016 further includes a near field communication (NFC) module to facilitate short-range communication. For example, the NFC module may be implemented based on a radio frequency identification (RFID) technology, an infrared data association (IrDA) technology, an ultra-wideband (UWB) technology, a bluetooth (BT) technology, and other technologies.

In some embodiments, the user equipment 3000 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for performing the methods described above.

In some embodiments, there is further provided a non-transitory computer-readable storage medium including an instruction, for example, the memory 3004 including an instruction. The instruction may be executed by the processor 3020 of the user equipment 3000 to complete the above method. For example, the non-transitory computer-readable storage medium may be a ROM, a random access memory (RAM), a CD-ROM, a magnetic tape, a floppy disk, an optical data storage device, or the like.

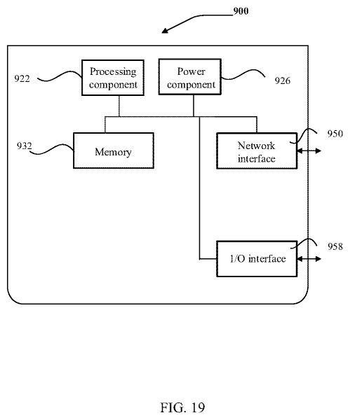

As shown in FIG. 19, it shows a structure of a base station according to some embodiments of the present disclosure. For example, the base station 900 may be provided as a network side device. Referring to FIG. 19, the base station 900 includes a processing component 922 that further includes one or more processors, and memory resources represented by the memory 932 for storing instructions, such as applications, that may be executed by the processing component 922. The application stored in the memory 932 may include one or more modules each corresponding to a set of instructions. In addition, the processing component 922 is configured to execute the instructions to perform any of the foregoing method applied to the base station.

The base station 900 may also include a power component 926 configured to perform power management of the base station 900, a wired or wireless network interface 950 configured to connect the base station 900 to a network, and an input/output (I/O) interface 958. The base station 900 may operate based on an operating system stored in the memory 932, such as Windows Server™, MAC OS X™, Unix™, Linux™, FreeBSD™, or the like.

Other embodiments of the present disclosure will be apparent to those skilled in the art from consideration of the description and practice of the present disclosure. The present disclosure is intended to cover any variations, uses, or adaptations of the present disclosure following the general principles of the present disclosure and including the common general knowledge and conventional technical means in the art not disclosed in the present disclosure. The description and examples should be considered as examples only, and the true scope and spirit of the present disclosure are indicated by the following claims.

It will be appreciated that the present disclosure is not limited to the precise structure that has been described above and illustrated in the accompanying drawings, and that various modifications and changes may be made without departing from the scope of the present disclosure. The scope of the present disclosure is limited only by the appended claims.

1. A method for positioning, performed by user equipment (UE), the method comprising:
determining time information of a global navigation satellite system (GNSS) measurement according to measurement configuration information; and
determining, according to an execution rule, whether to perform the GNSS measurement within a time range indicated by the time information.

2. The method according to claim 1, wherein determining, according to the execution rule, whether to perform the GNSS measurement within the time range indicated by the time information comprises one of:
in response to determining that an available duration of current GNSS position information of the UE is greater than a predetermined duration threshold, not performing the GNSS measurement; or
in response to determining that the available duration is less than or equal to the predetermined duration threshold, performing the GNSS measurement.

3. The method according to claim 2, wherein the predetermined duration threshold is greater than or equal to a measurement period duration of the GNSS measurement, and the time range indicated by the time information comprises the measurement period duration.

4. The method according to claim 1, further comprising one of:
in response to the UE completing the GNSS measurement within the time range, sending first response information to an access network device;
in response to the UE determining not to perform the GNSS measurement, sending second response information to the access network device; or
in response to the UE determining not to perform the GNSS measurement, not sending GNSS assistance information associated with the GNSS measurement to the access network device within a feedback time period associated with the time range.

5. The method according to claim 4, further comprising:
sending the first response information or the second response information on a transmission resource indicated by trigger information, wherein the trigger information is used to trigger the UE to perform the GNSS measurement within the time range indicated by the time information.

6. The method according to claim 1, wherein
the execution rule is predefined.

7. The method according to claim 1, further comprising at least one of:
receiving configuration information that indicates the execution rule;
receiving trigger information, wherein the trigger information is used to trigger the UE to perform the GNSS measurement within the time range indicated by the time information; or
receiving the measurement configuration information.

8. (canceled)

9. The method according to claim 7, wherein the measurement configuration information is carried in one of:
radio resource control (RRC) signaling;
a medium access control control unit (MAC CE); or
physical layer signaling.

10. A method for positioning, performed by an access network device, the method comprising:
sending measurement configuration information, wherein the measurement configuration information is used by user equipment (UE) to determine time information of a global navigation satellite system (GNSS) measurement, and determine, according to an execution rule, whether to perform the GNSS measurement within a time range indicated by the time information.

11. The method according to claim 10, wherein the execution rule comprises one of:
in response to determining that an available duration of current GNSS position information of the UE is greater than a predetermined duration threshold, the UE does not perform the GNSS measurement; or
in response to determining that the available duration is less than or equal to the predetermined duration threshold, the UE performs the GNSS measurement.

12. The method according to claim 11, wherein the predetermined duration threshold is greater than or equal to a measurement period duration of the GNSS measurement, and the time range indicated by the time information comprises the measurement period duration.

13. The method according to claim 10, further comprising one of:
receiving first response information, wherein the first response information is sent by the UE after completing the GNSS measurement within the time range;
receiving second response information, wherein the second response information is sent by the UE when determining not to perform the GNSS measurement; or
in response to not receiving GNSS assistance information sent by the UE, determining that the UE does not perform the GNSS measurement.

14. The method according to claim 13, further comprising:
receiving the first response information and/or the second response information on a transmission resource indicated by trigger information, wherein the trigger information is used to trigger the UE to perform the GNSS measurement within the time range indicated by the time information.

15. The method according to claim 10, wherein
the execution rules is predefined.

16. The method according to claim 10, further comprising at least one of:
sending configuration information that indicates the execution rule; or
sending trigger information, wherein the trigger information is used to trigger the UE to perform the GNSS measurement within the time range indicated by the time information.

17. The method according to claim 10, wherein the measurement configuration information is carried in one of:
radio resource control (RRC) signaling;
a medium access control control unit (MAC CE); or
physical layer signaling.

18. (canceled)

19. (canceled)

20. A communication device comprising:
a memory that stores an executable instruction;
one or more processors that are communicatively coupled to the memory,
wherein the executable instruction when collectively executed by the one or more processors cause the communication device to:
determine time information of a global navigation satellite system (GNSS) measurement according to measurement configuration information; and
determine, according to an execution rule, whether to perform the GNSS measurement within a time range indicated by the time information.

21. A non-transitory computer storage medium storing a computer executable program, the computer executable program is when executed by a processor of the UE, cause the UE to perform the method according to claim 1.

22. A communication device, comprising:
a memory that stores an executable instruction;
one or more processors that are communicatively coupled to the memory,
wherein the executable instruction when collectively executed by the one or more processors cause the communication device to act as the access network device and perform the method according to claim 10.

23. A non-transitory computer storage medium storing a computer executable program, the computer executable program when executed by a processor of the access network device, cause the access network device to perform the method according to claim 10.
